(19) United States
(12) Patent Application Publication
(10) Pub. No.: US 2023/0236665 A1
(43) Pub. Date: Jul. 27, 2023

(54) HEAD-MOUNTED DISPLAY SENSOR STATUS

(71) Applicant: Hewlett-Packard Development Company, L.P., Spring, TX (US)

(72) Inventors: Joseph Michael Nouri, Fort Collins, CO (US); Robert Scott Rawlings, Fort Collins, CO (US)

(73) Assignee: Hewlett-Packard Development Company, L.P., Spring, TX (US)

(21) Appl. No.: 18/007,155

(22) PCT Filed: Jul. 30, 2020
(86) PCT No.: PCT/US2020/044235

§ 371 Date: Jan. 27, 2023

(51) Int. Cl. G06F 3/01; G02B 27/00; G02B 27/01; F21V 8/00

(52) U.S. Cl. CPC G06F 3/013; G06F 3/015; G02B 27/0093; G02B 27/017; G02B 27/0101; G02B 6/0073; G02B 2027/0178; G02B 2027/0138; G02B 2027/014

(57) ABSTRACT

An example device comprises: a head-mounted display; a housing for the head-mounted display, the housing including an external surface; sensors to monitor a wearer of the head-mounted display; a visual indicator at the external surface; and a controller. The controller is generally to: control subsets of the sensors to be on or off based on respective permissions for usage of subsets of the sensors; and control the visual indicator to indicate respective status of the subsets of the sensors.

### BACKGROUND

Head-mounted displays, that include sensors to monitor a wearer thereof, are often used in training environments, gaming environments, and the like.

### BRIEF DESCRIPTION OF THE DRAWINGS

Reference will now be made, by way of example only, to the accompanying drawings in which:

FIG. 1 is a rear perspective view of an example device that includes a head-mounted display, sensors and visual indicators to indicate respective status of the subsets of the sensors.

FIG. 2 is a rear perspective view another example device that includes a head-mounted display, sensors and visual indicators to indicate respective status of the subsets of the sensors.

FIG. 3 is a block diagram of the example device of FIG. 2.

FIG. 4 is a block diagram of an example system including computing devices to control sensors and visual indicators at devices that include head-mounted displays, based on permissions.

FIG. 5 is a flow diagram of an example method to control sensors and visual indicators at devices that include head-mounted displays, based on permissions.

FIG. 6 is a block diagram of an example system including engines to control sensors and visual indicators at devices that include head-mounted displays, based on permissions.

### DETAILED DESCRIPTION

Head-mounted displays, that include sensors to monitor a wearer thereof, are often used in training environments gaming environments, and the like. However, as measurements of the wearer via sensors become more sophisticated, more information may be determined from sensor data about a wearer's state. For example, a cognitive load of a wearer; a valence of the wearer; an arousal of the wearer; an expression of the wearer, and the like, may be determined. As such, it may be important to determine and manage permissions for usage of sensors from the wearer.

In particular, an aspect of the present specification provides a device comprising: a head-mounted display; a housing for the head-mounted display, the housing including an external surface; sensors to monitor a wearer of the head-mounted display; a visual indicator at the external surface; and a controller to: control subsets of the sensors to be on or off based on respective permissions for usage of subsets of the sensors; and control the visual indicator to indicate respective status of the subsets of the sensors.

Another aspect of the present specification provides a method comprising: determining, at a computing device, permissions for monitoring states of wearers of devices that include: head-mounted displays, sensors to monitor the states, and a visual indicator to indicate respective status of subsets of the sensors to monitor respective states of the wearers; the permission indicating whether consent for monitoring a respective state has been granted or not granted by the wearers; and communicating, from the computing device, to the devices, commands indicative of the permissions to: control subsets of the sensors at the devices to turn on or off depending on the permissions; and control the visual indicator or the head-mounted display to indicate the respective status of the subsets of the sensors.

Another aspect of the present specification provides a system comprising: a permission determination engine to determine a permission indicating whether consent for monitoring a respective state of a wearer of a device has been granted or not granted by the wearer, the device including a head-mounted display, sensors to monitor states of the wearer, subsets of the sensors grouped according to determining respective states of the wearer via monitoring respective body parts of the wearer, and a visual indicator to indicate respective status of the subsets of the sensors; a sensor control engine to control a respective subset of the sensors for monitoring the respective state of the wearer to be on or off depending on the permission for the respective state; a permission indication control engine to control the visual indicator or the head-mounted display to indicate whether the consent for monitoring the respective state of the wearer of a device has been granted or not granted by the wearer; and a state determination engine to determine states of the wearer of the device based on respective sensor data received from the subsets of the sensors.

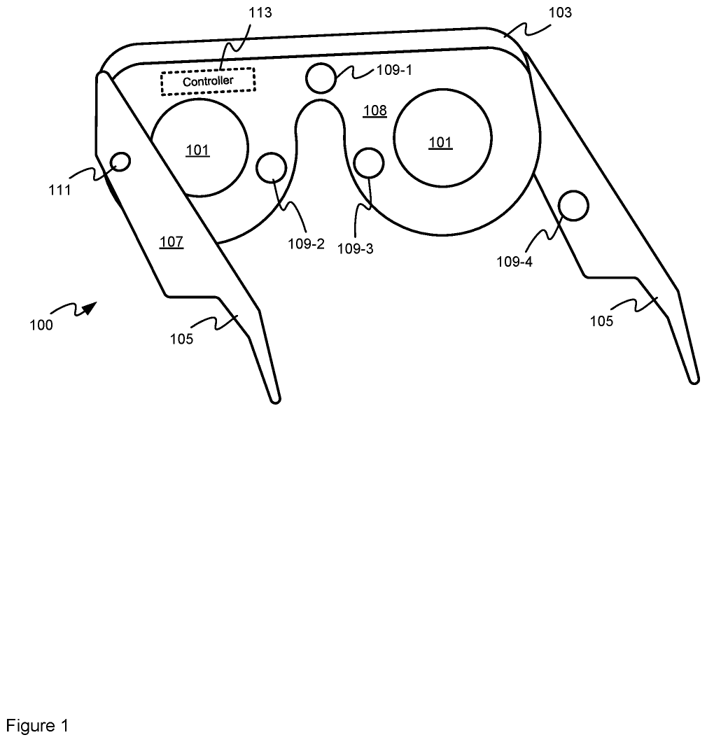

FIG. 1 is a perspective view of an example device 100 for managing head-mounted display sensor status. The device 100 generally comprises a head-mounted display 101, which, as depicted, includes two displays with lenses etc., one for each eye of a wearer.

The device 100 further includes a housing 103 for the head-mounted display 101 provided, for example, in the form of glasses and/or goggles, and the like, which, as depicted, includes arms 105 which are adapted to rest on the ears of a wearer. However, the housing 103 may be in any suitable format.

In general, however, the housing 103 includes an external surface 107 which is viewable (e.g. by a supervisor, and the like, of a wearer of the device 100 and/or an operator of a console device, described below) when a wearer is wearing the device 100. As depicted, the housing 103 further includes an internal surface 108 which may, for example, comprise a wearer-facing surface. In particular, the perspective of FIG. 1 shows the internal surface 108 and a portion of the external surface 107 including the arms 105. While a front of the device 100 is not shown, the external surface 107 is generally understood to extend across the front of the device 100.

The device 100 may be used in a training environment, with the head-mounted display 101 used to provide a virtual reality experience and/or environment, and/or an augmented reality experience and/or environment for the wearer. For example images may be rendered and/or provided at the head-mounted display 101 which are viewed by a wearer of the device 100e (e.g. on their head), and the images may be updated as the wearer moves their head, and the like to provide a virtual reality experience and/or environment, and/or an augmented reality experience and/or environment for the wearer. For example, the device 100 may be used to train employees to perform a task by controlling (e.g. via a host device in communication with the device 100) to provide images, and the like, for rendering at the head-mounted display 101 and which may change and/or move as a wearer moves their head to perform a training task. However, the device 100 may be used in other types of environments, such as gaming environments, simulators (e.g. cockpit simulators), and the like.

Furthermore, the head-mounted display 101 may be partially transparent, for example for use in augmented reality applications such that a wearer of the device 100 may view images on the head-mounted display 101 as well as objects, and the like through the head-mounted display 101; and/or the head-mounted display 101 may be not be transparent (and/or operated in an opaque mode) for use in virtual reality applications.

Regardless, during use of the device 100 by a wearer, a state of the wearer may be electronically monitored via sensors, for example to determine how the wearer is reacting to training, gaming, a simulation, and the like, being provided.

For example, as depicted, the device 100 comprises sensors 109-1, 109-2, 109-3, 109-4 to electronically monitor a wearer of the head-mounted display 101 and/or the device 100. The sensors 109-1, 109-2, 109-3, 109-4 are interchangeably referred to hereafter, collectively, as the sensors 109 and, generically, as a sensor 109. While four sensors 109 are depicted as being located at the internal surface 108 and/or at an arm 105 of the housing 103, the device 100 may comprise any suitable number of sensors 109 located at any suitable location at the device 100.

The sensors 109 are generally to measure and/or electronically monitor body parts and/or body part movements of a wearer of the device 100. For example, the sensors 109 may include a first camera and/or an eye-facing camera for acquiring images of an upper part of face and/or eyes of the wearer (e.g. to detect pupil size dilation), a second camera and/or a mouth-facing camera for acquiring images of a lower part of face and/or a mouth of the wearer (e.g. to detect mouth shape and/or expression), an electromyography (EMG) device, a heart-rate monitor, and the like, however any suitable sensors are within the scope of present examples.

Sensor data from subsets of the sensor 109 may be used to determine states of a wearer of the device 100. For example, respective images from an eye-facing camera and a mouth-facing camera may be used to determine an expression of a wearer. Similarly, images from an eye-facing camera, which show pupil dilation, and data from a heart-rate monitor, which indicate heart rate, may be used to determine a cognitive load of a wearer. However, any suitable state of the wearer may be determined, depending on types of the sensors 109, and/or available subsets of the sensors 109, and the like. Hence, in general, data from subsets of the sensors 109 may be used to determine a state and/or states a wearer of the device 100 including, but not limited to: a cognitive load of a wearer; a valence of the wearer (e.g. how negative (sad) to positive (happy); an arousal of the wearer (e.g. how energetic is the wearer); an expression of the wearer; and the like; and/or any other suitable state of the wearer.

However, such determination and/or detection of states may raise privacy concerns for the wearer, and/or a supervisor, and the like, supervising electronic monitoring of the wearer. As such, prior to usage of the device 100, permissions for monitoring states of the wearer may be obtained from the wearer, for example by way of electronically obtaining such permissions from the wearer, as described in more detail below. Consent data indicating such permissions may be stored at a memory (not depicted) of the device 100 and/or stored at a host device and/or a console device with which the device 100 communicates. While consent data is described in further detail below, the consent data generally comprises any suitable data indicative of whether or not the wearer of the device 100 has granted consent and/or permission to monitor certain states of the wearer (e.g. via the sensors 109); an example of consent data may be “yes” or “no” as to the wearer of the device 100 having respective granted or not granted consent to monitor a given state, however the consent data may be in any suitable format (e.g. “1” for “yes” and “0” for “no” and the like).

As will be described in more detail below, when a permission for a particular state is granted, a subset of the sensors 109 (e.g. from which sensor data is used to determine the particular state) are controlled to be on. However, when a permission for a particular state is not granted (and/or a wearer declines such a permission), a subset of the sensors 109 (e.g. from which sensor data is used to determine the particular state) are controlled to be off.

In general, it may be beneficial for a supervisor, and the like, supervising electronic monitoring of the wearer of the device 100 to be provided with a visual indication of such a permission and whether or not respective sensors 109 are on or off. Indeed, as used herein, the term “status of a sensor” may be understood to indicate an “on” or “off” status of a sensor 109.

Hence, as depicted, the device 100 further comprises: a visual indicator 111 at the external surface 107 (e.g. as depicted on an arm 105 of the housing 103) and a controller 113 (e.g. depicted in outline to indicate that the controller 113 is internal to the device 100). The controller 113 is generally to: control subsets of the sensors 109 to be on or off based on respective permissions for usage of subsets of the sensors 109; and control the visual indicator 111 to indicate respective status of the subsets of the sensors 109 (e.g. as associated with permissions).

The controller 113 may include a central processing unit (CPU), a microcontroller, a microprocessor, a processing core, a field-programmable gate array (FPGA), an application specific integrated circuit (ASIC), a PAL (programmable array logic), a PLA (programmable logic array), a PLD (programmable logic device), and the like. The controller 113 may cooperate with a memory (not depicted) to execute various instructions for implementing functionality of the device 100.

The visual indicator 111 may comprise a light, such as a light emitting diode (LED) and the like. However, the visual indicator 111 may include any suitable visual indicator including, but not limited to, any suitable combination of lights and/or LEDs and/or display screens, and the like.

While one visual indicator 111 is depicted, the device 100 may comprise more than one visual indicator 111, for example, a plurality of visual indicators 111 for indicating a plurality of respective statuses of a plurality of subsets of the sensors 109. However, the one visual indicator 111 may be for indicating status of one subset of the sensors 109 (e.g. for one permission) and/or for indicating status of more than one subset of the sensors 109 (e.g. for a plurality of permissions).

For example, when the visual indicator 111 is for indicating status of one subset of the sensors 109 (e.g. for one permission), the controller 113 may control the visual indicator 111 to be “on” when the permission for use of the one subset of the sensors 109 (e.g. for one permission) is obtained and hence the subset of the sensors 109 is “on”. Similarly, the controller 113 may control the visual indicator 111 to be “off” when the permission for use of the one subset of the sensors 109 (e.g. for one permission) is not obtained and hence the subset of the sensors 109 is “off”.

Alternatively, when the visual indicator 111 is for indicating status of one subset of the sensors 109, the controller 113 may control the visual indicator 111 to be a first color, such as green, when the permission for use of the one subset of the sensors 109 is obtained (e.g. and hence the subset of the sensors 109 is “on”); and the controller 113 may control the visual indicator 111 to be a second color, such as red, when the permission has not been obtained (e.g. and hence the subset of the sensors 109 is “off”).

When the visual indicator 111 is for indicating a plurality of respective statuses of a plurality of subsets of the sensors 109, the controller 113 may control the visual indicator 111 to cycle through being turned on and off, to cycle through indicating respective statuses of subsets of the sensors 109. For example, an “on” instance of the visual indicator 111 may indicate that a respective subset of the sensors 109 is “on” or “off” (e.g. green or red, as described above), and an “off” instance may be provided to indicate that the visual indicator 111 is being controlled to shortly show a next status. Hence, for example when the visual indicator 111 is to indicate three statuses (e.g. for subsets of the sensor 109 used to determine valence, arousal and expression), and when permissions for use of two subsets of the sensors 109 are obtained (e.g. for determining valence and arousal), but a permission for use of a third subset of the sensors 109 is not obtained (e.g. for determining expression), the visual indicator 111 may be controlled to flash “green” (then turn off briefly) “green” (then turn off briefly) “red” (then turn off briefly), and then cycle back to the beginning (e.g. to again flash “green”, “green”, “red.

Hence, the subsets of the sensors 109 may be grouped according to determining respective states of the wearer via monitoring respective body parts and/or body part movements of the wearer, and respective permissions may be associated with the respective states. For example one subset of the sensors 109 may monitor eye movement of the wearer of the device 100, and another subset of the sensors 109 may monitor facial expression and/or mouth movement of the wearer of the device 100. Similarly, the visual indicator 111 may be to indicate respective status of the subsets of the sensors 109 via indicating respective states of the wearer. Hence, for example, a color, and the like, of the visual indicator 111 may indicate whether subsets of the sensors 109 are “on” or “off”, and such an indication may further indicate whether permission for determining states of the wearer associated with the subsets of the sensors 109 has been granted (and/or obtained) or not granted (and/or not obtained). As such, the visual indicator 111 may indicate to a supervisor whether a wearer of the device 100 has granted permissions for determining associated states.

In some examples, the controller 113 may be further to control the head-mounted display 101 to indicate the respective status of the subsets of the sensors 109, for example in a virtual reality and/or augmented reality screen and/or menu, and the like. Such control of the head-mounted display 101 to indicate the respective status of the subsets of the sensors 109 may indicate the status of the subsets of the sensors 109 to a wearer of the device 100, for example as the wearer may not be able to see the visual indicator 111.

As will be described in more detail below, the device 100 may comprise respective power rails for the sensors 109. In particular, the controller 113 may be further to control the sensors 109 to be on or off by turning on and off power to the respective power rails to the sensors 109 (e.g. via respective switches) when the controller 113 turns sensors 109 on or off. In other words, to better protect privacy of the wearer when a permission for use of a subset of the sensors 109 has not been provided, power to respective sensors 109 are turned off such that data from the sensors 109 is not collected and/or may not be collected.

While not depicted, in some examples, the device 100 may further comprise an input device to control whether consent for monitoring a respective state has been granted or not granted by the wearer. Such an input device may include a forward facing camera which may detect hand movement of the wearer such that the wearer may interact with a virtual reality and/or augmented reality screen and/or menu, and the like to grant or decline permission for monitoring a respective state. Alternatively, such an input device may comprise a glove, and the like, worn by a wearer of the device 100 to assist with interacting with a virtual reality and/or augmented reality screen and/or menu, and the like to grant or decline permission for monitoring a respective state. Alternatively, such an input device may comprise a physical button and/or physical buttons and/or a keypad and/or a pointing device and/or a touchpad, and the like, at the housing 103 to assist with interacting with a virtual reality and/or augmented reality screen and/or menu, and the like to grant or decline permission for monitoring a respective state. However, any suitable input device is within the scope of the present specification.

In some examples, the permissions are determined at the device 100. However, in other examples, the device 100 may further comprise a communication interface to: communicate, to a computing device (e.g. a host device and/or a console device), data indicating consent data to control the respective permissions at the computing device; and receive, from the computing device, the respective permissions. Put another way, the permissions may not be determined at the device 100, but may be determined and stored at an external computing device, and received at the device 100 from external computing device. Put yet another way, the wearer of the device 100 may use an input device to indicate granting or denial of a permission, and consent data indicating granting or denial of a permission may be communicated and/or transmitted to the external computing device which determines the permission, and conveys the permission back to the device 100. These examples show that the device 100 may be a component of a distributed computing environment in which the device 100 is used to receive input, and render images, and the like, at the head-mounted display 101, but that the computation of permissions based on the input, and/or determination of the images, may occur at an external computing device; in particular, such an external computing device may cooperate with the controller 113 to control the subsets of the sensors 109 and/or the visual indicator 111. Such an external computing device may be further to determine the images and communicate and/or transmit the images to the device 100 in a video stream for rendering at the head-mounted display 101.

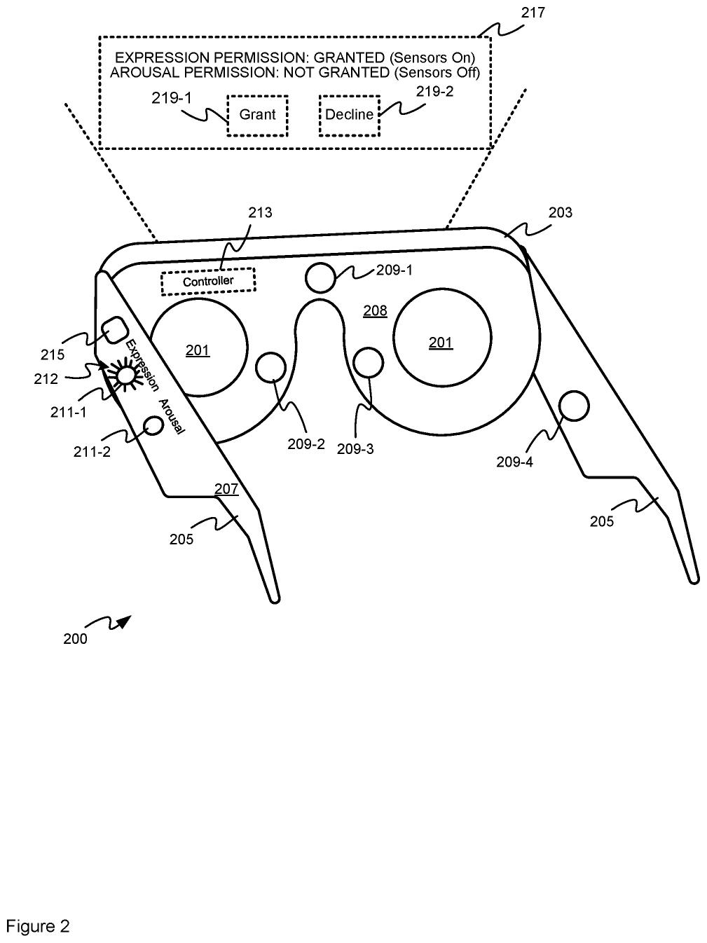

Attention is next directed to FIG. 2 which depicts a rear perspective view of another example device 200, that is similar to the device 100, with like components having like numbers, however in a “200” series rather than a “100” series. Hence, for example, the device 200 comprises a head-mounted display 201, a housing 203 that includes an external surface 205 with arms 207 and an internal surface 208, sensors 209-1, 209-2, 209-3, 209-4 (interchangeably referred to hereafter, collectively, as the sensors 209 and, generically, as a sensor 209), visual indicators 211-1, 211-2, and a controller 213, which are respectfully similar to the head-mounted display 101, the housing 103 with the external surface 107 and the arms 207, the sensors 209, the visual indicator 111 and the controller 213.

However, in contrast to the device 100, the device 200 includes two visual indicators 211-1, 211-2, interchangeably referred to hereafter, collectively, as the visual indicators 211 and, generically, as a visual indicator 211. For example, the visual indicator 211-1 is to indicate a respective status of the subset of the sensors 209 from which data is used to determine expression, which may be indicated by a label “Expression”; similarly, the visual indicator 211-2 is to indicate a respective status of the subset of the sensors 209 from which data is used to determine arousal, which may be indicated by a label “Arousal”.

As depicted, the visual indicator 211-1 is “on”, as indicated by lines 212 radiating therefrom (e.g. the lines 212 show light being emitted from the visual indicator 211-1); as such, as will be explained hereafter, the permission for using a subset of the sensors 209 from which data is used to determine expression has been obtained and hence, a status of an associated subset of sensors 209 is understood to be “on”. However, the visual indicator 211-2 is “off”, as indicated by a lack of lines radiating therefrom; as such, as will be explained hereafter, the permission for using a subset of the sensors 209 from which data is used to determine arousal has not been obtained and/or has been denied, and hence, a status of an associated subset of sensors 209 is understood to be “off”.

While only two visual indicators 211 are depicted, the device 200 may include any suitable number of visual indicators 211, for example a plurality of visual indicators 211 for indicating a plurality of permissions and/or statuses of subsets of the sensors 209, in a one-to-one relationship.

As also seen in FIG. 2, the device 200 includes an input device 215 in the form of a touchpad. As also depicted in FIG. 2, the head-mounted display 201 is being controlled to render a menu 217 (e.g. in a virtual reality and/or augmented reality screen, as indicated by the menu 217 being depicted in broken lines) which is viewable by a wearer of the device 200 viewing the head-mounted display 201. As depicted, the menu 217 may indicate that “Expression” permission has been obtained and/or granted, and hence an associated subset of the sensors 209 are “on”, but that “Arousal” permission has not been obtained and/or not granted, and hence an associated subset of the sensors 209 are “off”. As depicted, the menu 217 further includes virtual buttons 219-1, 219-2 (e.g. referred to interchangeably hereafter the virtual buttons 219 and/or a virtual button 219) for respectfully granting or declining permission to turn on an associated subset of the sensors 209 to determine arousal.

A wearer of the device 200 may operate the input device 215 (and/or another input device) to select the virtual button 219-1 to grant permission to turn on the associated subset of the sensors 209 to determine arousal; in response to selecting the virtual button 219-1, the controller 213 may control the associated subset of the sensors 209 to turn on, and turn on the visual indicator 211-2.

Alternatively, the wearer of the device 200 may operate the input device (and/or another input device) 215 to select the virtual button 219-2 to decline permission to turn on the associated subset of the sensors 209 to determine arousal.

While not depicted, permission for determining “Expression” may be obtained in a similar manner.

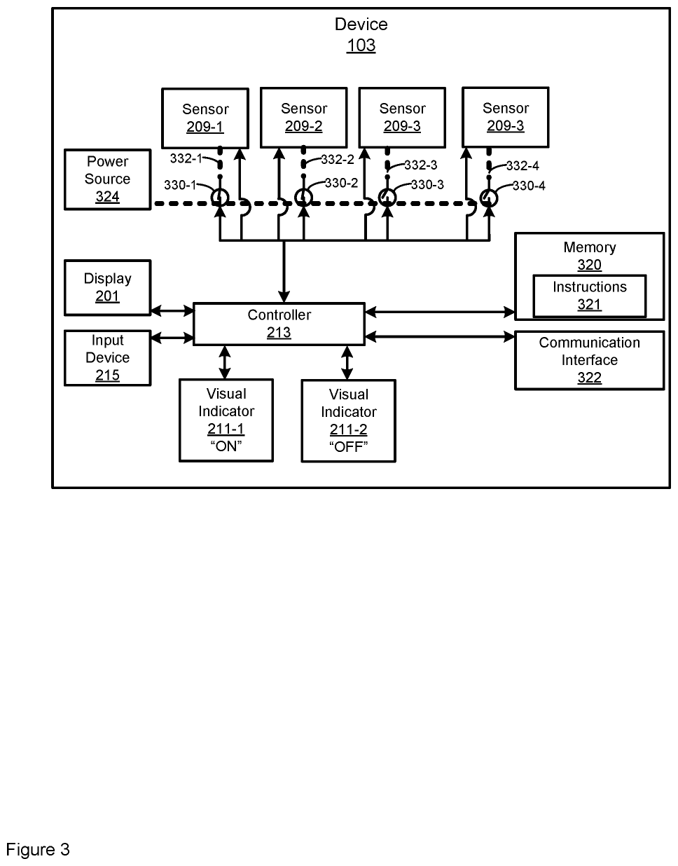

Attention is next directed to FIG. 3 which depicts a block diagram of the device 200. As depicted, the device 200 comprises the controller 213 interconnected with the head-mounted display 201, the sensors 209, the visual indicators 211, the input device 215, a memory 320 storing instructions 321, and a communication interface 322.

The memory 320 may include any suitable non-transitory machine-readable storage medium that may be any electronic, magnetic, optical, or other physical storage device including, but not limited to, a volatile memory (e.g., volatile RAM, a processor cache, a processor register, etc.), a non-volatile memory (e.g., a magnetic storage device, an optical storage device, flash memory, read-only memory, non-volatile RAM, etc.), and/or the like. The controller 213 is to execute the instructions 321 stored in the memory 320, the instructions 321 to cause the controller 213 to: control subsets of the sensors 209 to be on or off based on respective permissions for usage of subsets of the sensors 209; and control the visual indicators 211 to indicate respective status of the subsets of the sensors 209.

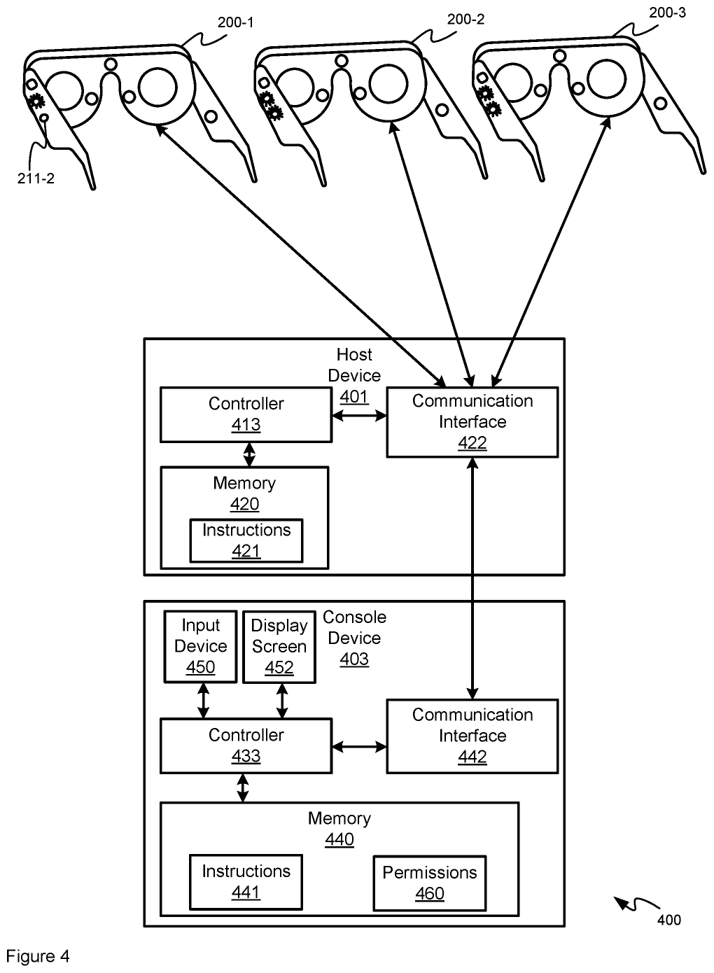

The communication interface 322 is to communicate with a network such as a wired and/or wireless network which may include a cellular network and/or a WiFi network and/or a local network, and the like, for example to communicate with a host device and/or a console device, as described in more detail below with respect to FIG. 4.

As depicted, the device 200 further comprises a power source 324, such a battery, and the like. The power source 324 is generally to power the components of the device 200. For clarity, in FIG. 3, power connections between components are depicted using heavy dashed lines, while data connections between components are depicted using double-ended arrows.

In particular, the power source 324 is to power the sensors 209 via respective switches 330-1, 330-2, 330-3, 330-4 (e.g. referred to interchangeably hereafter the switches 330 and/or a switch 330) and power rails 332-1, 332-2, 332-3, 332-4 (e.g. referred to interchangeably hereafter the power rails 332 and/or a power rail 332). The switches 330 may comprise transistors and/or power transistors, and the like, controlled by the controller 213 based on the permissions. The power rails 332 generally provide power to the sensors 209 based on whether or not a respective switch 330 is on or off. While power connections from the power source 324 to other components of the device 200 are not depicted, such power connections, where suitable, are nonetheless understood to be present.

Continuing with the example where permission to determine expression has been obtained, and hence permission to use a subset of associated sensors 209 has been obtained, it is understood that the sensors 209-1, 209-2 are used to determine expression. As such, the controller 213 has controlled associated switches 330-1, 330-2 to be closed such that the power rails 332-1, 332-2 supply power to the sensors 209-1, 209-2, and hence the sensors 209-1, 209-2 are “on”. Similarly, the controller 213 has controlled the visual indicator 211-1 to be “ON”, as also indicated in FIG. 3.

Similarly, continuing with the example where permission to determine arousal has not been obtained, and similarly permission to use a subset of associated sensors 209 has not been obtained, it is understood that the sensors 209-3, 209-4 are used to determine arousal. As such, the controller 213 has controlled associated switches 330-3, 330-4 to be open such that the power rails 332-3, 332-4 do not supply power to the sensors 209-3, 209-4, and hence the sensors 209-3, 209-4 are “off”. As such, sensor data from the sensors 209-3, 209-4 may not be obtained, protecting a privacy of the wearer of the device 200 with respect to determination of arousal. Similarly, the controller 213 has controlled the visual indicator 211-2 to be “OFF”, as also indicated in FIG. 3.

It is understood that, in response to obtaining permission to determine arousal, the controller 213 may control associated switches 330-3, 330-4 to be closed such that the power rails 332-3, 332-4 supply power to the sensors 209-3, 209-4, and hence the sensors 209-3, 209-4 are controlled to be “on” and the controller 213 may control the visual indicator 211-2 to be “ON”.

While not depicted, the device 200 (and/or the device 100) may further comprise a clock, and the like (including, but limited to a clock of the controller 213) for determining a time which may be used to time-stamp sensor data from the sensors 209.

While not depicted, the device 200 (and/or the device 100) may further comprise any suitable combination of motion sensors, accelerometers, gyroscopes, magnetometers, and the like, for determining motion of a wearer of the device 200 (and/or the device 100), and data from such motions sensors, and the like, may be communicated to a host device, and the like, generating images for rendering at the head-mounted display 201 in a virtual reality and/or augmented reality environment.

Attention is next directed to FIG. 4 which depicts a block diagram of an example system 400 including computing devices to control sensors and visual indicators at devices that include head-mounted displays, based on permissions.

As depicted, the system 400 includes a plurality of the devices 200 (e.g. in particular three devices 200-1, 200-2, 200-3) which are understood to be in use by respective wearers (not depicted). While three devices 200 are depicted, the system 400 may include any suitable number of devices 200.

While for simplicity, the various components of the devices 200 are not numbered, other than the visual indicator 211-2 of the device 200-1, such components, as described with respect to FIG. 2 and FIG. 3, are nevertheless understood to be present. In particular, as depicted, the visual indicator 211-2 is understood to be “off” while the other visual indicators 211 are understood to be “on”, indicating that permissions for determining expression, and use of associated subsets of sensors 209, have been obtained for the devices 200; however, permissions for determining arousal, and use of associated subsets of sensors 209, have been obtained for the devices 200-2, 200-3, but not for the device 200-1.

As depicted, the system 400 further comprises a host device 401 and a console device 403, which comprise respective computing devices having functionality as described hereafter. While the devices 401, 403 are depicted as being separate devices, in other examples, the devices 401, 403 may be combined and/or partially combined, and/or functionality described herein with respect to the host device 401 and/or the console device 403 may be distributed in any suitable manner between the devices 401, 403 (as well as, in some examples, to the devices 200).

As depicted, the host device 401 comprises a controller 413, a memory 420 storing instructions 421 and a communication interface 422, which are respectively similar to the controller 213, the memory 320, the instructions 321 and the communication interface 322, as described above, but adapted for the functionality of the host device 401. For example, the controller 413 may have more and/or better and/or faster processing resources than the controller 213 as the controller 413 may be to generate images for rendering at the respective head-mounted displays 201 of the devices 200. Similarly, the memory 420 may have a larger storage capacity than the memory 320, and the instructions 421 are for implementing the functionality of the host device 401, for example when the instructions 421 are executed by the controller 413. Such instructions 421 may enable the controller 413 to generate images for rendering at the respective head-mounted displays 201, amongst other possibilities described herein.

Similarly, as depicted, the console device 403 comprises a controller 433, a memory 440 storing instructions 441 and a communication interface 442, which are respectively similar to the controller 213, the memory 320, the instructions 321 and the communication interface 322, as described above, but adapted for the functionality of the console device 403. For example, the controller 433 may have more and/or better and/or faster processing resources than the controller 213 as the controller 433 may be to receive sensor data from the sensors 209 of the devices 200 and determine respective states of the wearers for which permission has been received, as well as to control other interactions with the devices 200. Similarly, the memory 440 may have a larger storage capacity than the memory 320, and the instructions 441 are for implementing the functionality of the console device 403, for example when the instructions 441 are executed by the controller 433. Such instructions 441 may enable the controller 433 to determine respective states of the wearers for which permission has been received, amongst other possibilities, as described herein.

As depicted, the console device 403 further comprises an input device 450 (e.g. a keyboard and/or a pointing device, and the like), and a display screen 452 with which an operator of the console device 403 may interact to review respective states of the wearers as determined by the console device 403, and the like, and/or to cause the devices 200 to request permissions to monitor respective states and/or use respective subsets of the sensors 209 used to monitor such respective states. Such an operator may include a supervisor supervising training of the wearers of the devices 200, amongst other possibilities.

As depicted, the memory 440 further stores data 460 indicative of permissions as described herein; the data 460 may indicate that respective permissions are granted or denied. In some examples, indications of such data 460 may be rendered at the display screen 452.

As depicted, the communication interfaces 422, 422 are in communication with each other, and the communication interface 422 is in communication with the devices 200 (e.g. with respective communication interfaces 322), as indicated by double-ended arrows therebetween. As such, the host device 401 may act as a proxy for the console device 403 in communicating with the device 200, and vice versa.

Communication between the communication interfaces 422, 422 may be wired and/or wireless. Communication between the communication interface 422 and the devices 200 may generally be wireless, though wired connections therebetween are within the scope of the present specification.

Hence, in general, the host device 401 is used to communicate directly with the devices 200, generate images for rendering, and the like, while the console device 403 may be used by an operator, such as a supervisor, and the like, to control and/or monitor a training experience, and the like, for wearers of the device 200 (e.g. provides in a virtual reality and/or augmented reality environment), via the host device 401. While as depicted, the host device 401 does not include an input device and/or a display screen, in other examples, the host device 401 may include an input device and/or a display screen.

As will be next described, the console device 403 (and/or the host device 401 and/or a combination thereof), may be used to determine permissions and control the subsets of the sensors 209 at the devices 200 to turn on or off, and similarly control the visual indicators 211 at the devices 200 to turn on or off, depending on the permissions.

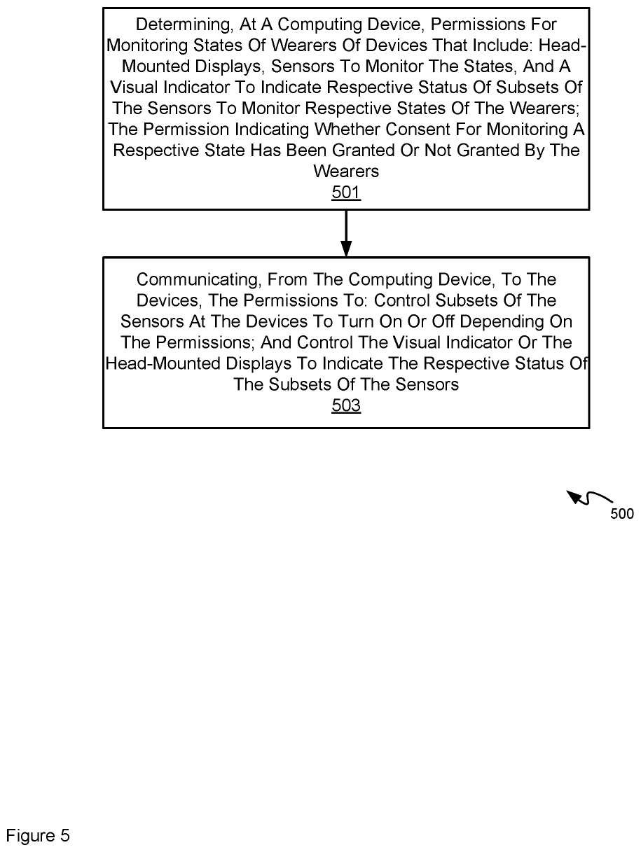

Referring to FIG. 5, a flowchart of an example method 500 to implement a method to control sensors and visual indicators at devices that include head-mounted displays, based on permissions. While reference is made to the method 500 being implemented using a computing device, the method 500 may be performed with the system 400, and at least partially by the console device 403 (and/or the host device 401) and/or a controller and/or controllers thereof (e.g. the controller 433 and/or the controller 413). The method 500 may be one way in which the system 400 may be configured. Furthermore, the following discussion of method 500 may lead to a further understanding of the system 400, and its various components. Furthermore, it is to be emphasized, that method 500 may not be performed in the exact sequence as shown, and various blocks may be performed in parallel rather than in sequence, or in a different sequence altogether.

Beginning at a block 501, a computing device determines permissions for monitoring states of wearers of devices 200 that include: head-mounted displays 201, sensors 209 to monitor the states, and a visual indicator 211 and/or visual indicators 211 to indicate respective status of subsets of the sensors 209 to monitor respective states of the wearers. As has already been described, a permission indicates whether consent for monitoring a respective state has been granted or not granted by the wearers of the devices 200.

As has also already been described such states may include, but are not limited to: a cognitive load of a wearer; a valence of the wearer (e.g. how negative (sad) to positive (happy); an arousal of the wearer (e.g. how energetic is the wearer); an expression of the wearer; and the like; and/or any other suitable state of the wearer.

In particular, at the block 501, the computing device may determine the permissions by: receiving, at the computing device, from the device, consent data indicating whether the consent for monitoring of the respective state has been granted or not granted. In a particular example, the devices 200 may be controlled by the console device 403 and/or the host device 401 to render menus, similar to the menu 217, when the devices 200 are turned on, and/or at the beginning of a training session, and the like, to request permissions for monitoring respective states via virtual buttons, and the like, similar to the virtual buttons 219. Consent data determined in such a manner may be communicated by the devices 200, to the console device 403, via the communication interfaces 422, 442.

Alternatively, wearers of the devices 200 may interact with the host device 401 and/or the console device 403 (e.g. prior to wearing the devices 200) to interact with a graphic user interface, and the like, rendered at a display screen thereof, to provide permissions which may be associated with credentials of the wearers for example as stored at the data 460. The devices 200 may be later logged into by a respective wearer using the credentials and the console device 403 may receive such credentials (e.g. via the communication interfaces 422, 422) from the devices 200, along with identifiers of the devices 200 (e.g. a network address, a Media Access Control (MAC) address, and the like) and coordinate such credentials and identifiers with the data 460 to determine which permissions have been granted at respective devices 200. Indeed, the console device 403 and/or the host device 401 are generally enabled to communicate, and/or uniquely communicate with the devices 200 based on the identifiers such that specific data and/or images may be respectively customized for the devices 200.

At a block 503, the computing device communicates, to the devices 200, commands indicative of the permissions to: control subsets of the sensors 209 at the devices 200 to turn on or off depending on the permissions; and control the visual indicator(s) 211 or the head-mounted display 201 to indicate the respective status of the subsets of the sensors 209 (e.g. similar to the menu 217). Similarly, commands may be generated and transmitted by the console device 403 (e.g. via the host device 401) to the devices 200 which may be processed by respective controller 213 thereof to control respective visual indicator(s) 211 to be on or off, and/or to provide a particular color, depending on the permissions; and/or the head-mounted display 201 may be controlled to provide an indication of the permissions (e.g. similar to the menu 217).

It is further understood that, until permissions are granted, associated subsets of sensors 209 may be “off” by way of respective switches 330 being open. As such, at the block 503, commands may be generated and transmitted by the console device 403 (e.g. via the host device 401) to the devices 200 which may be processed by respective controllers 213 thereof to control respective subsets of sensor 209 to be on, or remain off, depending on the permissions.

In some examples (e.g. in a training environment), there may be a policy, and the like, that respective sensors 209 at the devices 200 are to have a same respective status such that same states of the wearers of the devices 200 may be monitored.

Hence, in some examples, the method 300 may further comprise, the computing device in response to determining that a respective permission for a particular device 200 indicates that the consent for monitoring a respective state has not been granted (e.g. as determined from the data 460), communicating, to the particular device 200, a request to grant the respective permission. Such a request may again cause a menu, similar to the menu 217, to be provided to request the respective permission. Such communication may be via the communication interface 442 and/or the communication interface 422. Presuming that a wearer of the particular device 200 grants the respective permission (e.g. by interacting with a virtual button, such as the virtual button 419-1), the method 300 may yet further comprise the computing device receiving, from the particular device 200, consent data indicative of the consent for monitoring the respective state has been granted. However, at this point in communications between the devices 200, 401, 403, the particular device 200 itself may or may not store an indication of the consent for monitoring the respective state has been granted. As such, the method 300 may yet further comprise the computing device communicating, to the particular device 200, the respective permission to: control a respective subset of the sensors 209 at the particular device 200 to turn on; and control a respective visual indicator 211 at the particular device 200 to indicate the respective status of the respective subset of the sensors 209 at the particular device 200, as described previously. In particular, referring back to the example shown in FIG. 2 and FIG. 3, the sensors 211-3, 211-4 may be turned on via controlling the switches 330-3, 330-4, and the visual indicator 211-2 may be turned on accordingly.

In yet further examples, in a training environment, an operator of the console device 403 (e.g. who may be supervising training of the wearers of the devices 200) may prefer that respective sensors 209 at the devices 200 have a same respective status such that same states of the wearers of the devices 200 may be monitored. In these examples, a respective permission for a particular device 200 may indicate that consent for monitoring a respective state has not been granted, for example as indicated by the data 460. Such permissions may be rendered at the display screen 452 for review and/or the operator of the console device 403 may view the visual indicators 211 of the devices 200. In a particular example, the operator of the console device 403 may view the visual indicators 211 of the devices 200 and see that permissions have been granted for expression at the devices 200, but that permissions have been granted for arousal at the devices 200-2, 200-3, but not the device 200-1. For example, the wearer of the device 200-1 may have declined granting the permission in error, and the like.

As such, the operator of the console device 403 may operate and/or interact with the input device 450 to communicate with the device 200-1 to granting the permission for expression.

In particular, the method 300 may further comprise the computing device, in response to receiving input from an input device (e.g. the input device 450): communicating, to a particular device 200 for which permission for monitoring a respective state has not been granted, a request to grant the consent for monitoring the respective state; receiving, from the particular device 200, consent data indicative of the consent for monitoring the respective state has been granted; and communicating, to the particular device 200, the respective permission to: control a respective subset of the sensors 209 at the particular device 200 to turn on; and control a respective visual indicator 211 at the particular device 200 to indicate the respective status of the respective subset of the sensors at the particular device 200. In particular, in the example shown in FIG. 2 and FIG. 3, the sensors 211-3, 211-4 may be turned on via controlling the switches 330-3, 330-4, and the visual indicator 211-2 may be turned on accordingly.

It is further understood that, in some examples, the computing device implementing the method 300 (e.g. the console device 403 and/or the host device 401) may be further configured to handle collisions between turning sensors on and off. For example, one sensor 209 may be used to determine more than one state of a wearer of a device 200; when permission has been granted for determining a first state, but not a second state, both of which are determined using sensor data from a same sensor 209, the same sensor 209 may be turned on such that the first state may be determined. In these examples, the method 300 may include the computing device refraining from determining the second state regardless of available sensor data.

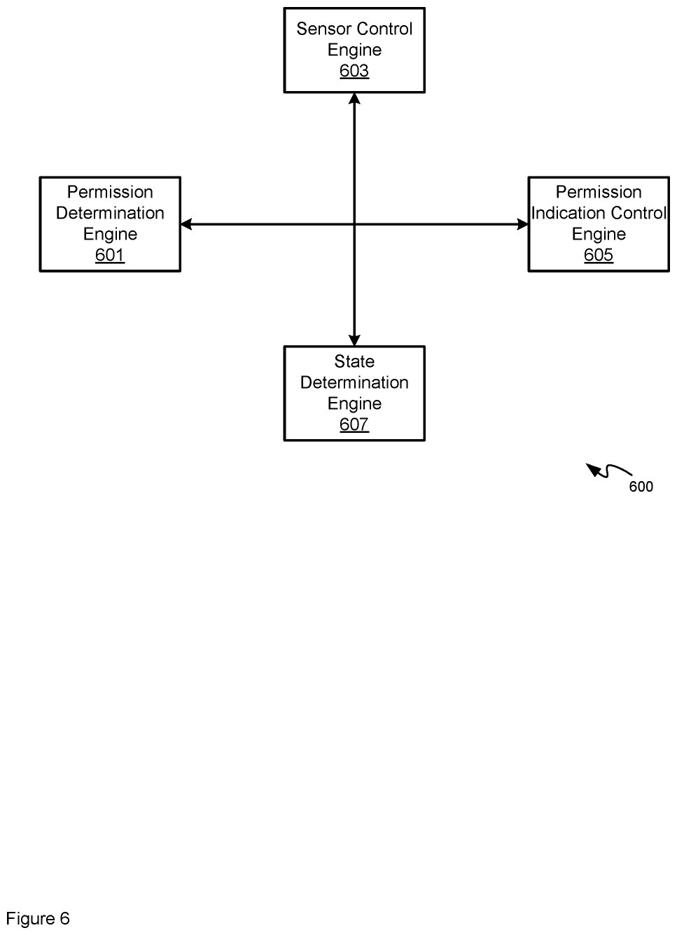

Attention is next directed to FIG. 6 which depicts an example system 600 that includes engines to control sensors and visual indicators at devices that include head-mounted displays, based on permissions. Communication between components and/or engines described herein is shown in the figures of the present specification as arrows therebetween.

Furthermore, as used herein, the term “engine” refers to hardware (e.g., a controller and/or processor, such as a central processing unit (CPU) an integrated circuit or other circuitry) or a combination of hardware and software (e.g., programming such as machine- or processor-executable instructions, commands, or code such as firmware, a device driver, programming, object code, etc. as stored on hardware). Hardware includes a hardware element with no software elements such as an application specific integrated circuit (ASIC), a Field Programmable Gate Array (FPGA), a PAL (programmable array logic), a PLA (programmable logic array), a PLD (programmable logic device), etc. A combination of hardware and software includes software hosted at hardware (e.g., a software module that is stored at a processor-readable memory such as random access memory (RAM), a hard-disk or solid-state drive, resistive memory, or optical media such as a digital versatile disc (DVD), and/or implemented or interpreted by a processor), or hardware and software hosted at hardware.

The engines of the system 600 may be implemented using the components of the system 400, for example, and/or any other suitable system. Hence, hereafter, the system 600 will be described with respect to the components of the system 400.

As depicted, the system 600 comprises a permission determination engine 601 to determine a permission indicating whether consent for monitoring a respective state of a wearer of a device 200 has been granted or not granted by the wearer. As has already been described, such a device 200 includes a head-mounted display 201, sensors 209 to monitor states of the wearer, subsets of the sensors 209 grouped according to determining respective states of the wearer via monitoring respective body parts of the wearer, and a visual indicator 211, and/or visual indicators 211, to indicate respective status of the subsets of the sensors 209. In some examples, the permission determination engine 601 may be implemented by the console device 403 and/or the host device 401, for example by way of receiving consent data from the devices 200.

The system 600 further comprises a sensor control engine 603 to control a respective subset of the sensors 209 for monitoring the respective state of the wearer to be on or off depending on the permission for the respective state. In some examples, the sensor control engine 603 may be implemented by the console device 403 and/or the host device 401, for example by way of transmitting commands to the devices 200 to cause respective controllers 213 thereof to turn respective sensors 209 on or off via the respective switches 330.

In some examples, the sensor control engine 603 may be further to: receive, from an input device (e.g. the input device 450 and/or another input device) or a communication interface (e.g. the communication interface 442 and/or the communication interface 422), input to turn the monitoring of the respective state on or off; and control the respective subset of the sensors 209 to be on or off further depending on the input to turn the monitoring of the respective state on or off. Put another way, an operator of the console device 403, and the like, may operate the input device 450 to turn off (or turn on) monitoring of particular states, and the console device 403 may responsively communicate commands to the devices 200 to turn off (or turn on) respective sensors 209 at the devices 200, as well as respective visual indicators 211. In examples where monitoring of a particular state is turned on, it is understood that permission for such monitoring has been obtained.

Hence, the sensor control engine 603 may be further to: receive, from an input device (e.g. the input device 450 and/or another input device) or a communication interface (e.g. the communication interface 442 and/or the communication interface 422), input to turn the monitoring of the respective state on or off at a plurality of devices 200 (e.g. including a particular device 200); and control the respective subset of the sensors 209 to be on or off at the plurality of the devices 200 depending on the input to turn the monitoring of the respective state on or off. As such, sensors 209 and visual indicators 211 of the devices 200 of the system 400 may all be placed into a same overall status to collect sensor data from the sensors 209 to determine same states of wearers of the devices 200. In other words, the operator of the console device 403 may use the input device 450 (and/or a command for doing so may be received at the communication interface 442 and/or the communication interface 422) to cause all the devices 200 to monitor the same respective states.

The system 600 further comprises a permission indication control engine 605 to control a visual indicator 211 or a head-mounted display 201 of a device 200 to indicate whether the consent for monitoring the respective state of the wearer of the device 200 has been granted or not granted by the wearer. In some examples, the permission indication control engine 605 may be implemented by the console device 403 and/or the host device 401, for example by way of transmitting commands to the devices 200 to cause respective controllers 213 thereof to control respective visual indicators 211 or head-mounted displays 201 thereof, for example to indicate the permissions to an operator of the console device 403 via the visual indicators 211 and/or to indicate permissions to a wearer of a device 200 via the head-mounted displays 201

In particular, the permission indication control engine 605 may be further to control a visual indicator 211 or a head-mounted display 201 of a device 200 to indicate whether consent for monitoring a respective state of a wearer of a device 200 has been granted or not granted by the wearer by: communicating data indicating the consent to a device 200 via a communication interface (e.g. the a communication interface 442 and/or the communication interface 422).

The system 600 further comprises a state determination engine 607 to determine states of the wearer of a device 200 based on respective sensor data received from the subsets of the sensors 209. In some examples, the state determination engine 607 may be implemented by the console device 403 and/or the host device 401, for example by way of sensor data from respective sensors 209 of the devices 200 and processing the sensor data to determine the various respective states.

In particular, the state determination engine 607 may be further to receive the respective sensor data with time stamps and determine the states of the wearer based on the respective sensor data by coordinating the respective sensor data based on the time stamps. Hence, for example, different sensor data from different sensors 209 at a particular device 200 may not be received concurrently; for example, images from an eye-facing camera generated at a first time may be received prior to receiving heart rate data from a heart-rater monitor also generated at about the first time. As such, the state determination engine 607 may coordinate the sensor data via time stamps to attempt to ensure that a state of a wearer for a particular time is based on sensor data collected at, or about, the particular time.

It should be recognized that features and aspects of the various examples provided above may be combined into further examples that also fall within the scope of the present disclosure.

1. A device comprising:
a head-mounted display;
a housing for the head-mounted display, the housing including an external surface;
sensors to monitor a wearer of the head-mounted display;
a visual indicator at the external surface;
a controller to:
control subsets of the sensors to be on or off based on respective permissions for usage of subsets of the sensors; and
control the visual indicator to indicate respective status of the subsets of the sensors.

2. The device of claim 1, wherein the controller is further to: control the head-mounted display to indicate the respective status of the subsets of the sensors.

3. The device of claim 1, wherein the subsets of the sensors are grouped according to determining respective states of the wearer via monitoring respective body parts of the wearer, the respective permissions associated with the respective states, the visual indicator to indicate respective status of the subsets of the sensors via indicating respective states of the wearer.

4. The device of claim 1, further comprising respective power rails for the sensors, and the controller is further to control the sensors to be on or off by turning on and off power to the respective power rails to the sensors.

5. The device of claim 1, further comprising:
an input device to control whether consent for monitoring a respective state has been granted or not granted by the wearer; and
a communication interface to: communicate, to a computing device, data indicating consent data to control the respective permissions at the computing device; and receive, from the computing device, the respective permissions.

6. A method comprising:
determining, at a computing device, permissions for monitoring states of wearers of devices that include: head-mounted displays, sensors to monitor the states, and a visual indicator to indicate respective status of subsets of the sensors to monitor respective states of the wearers; the permission indicating whether consent for monitoring a respective state has been granted or not granted by the wearers; and
communicating, from the computing device, to the devices, commands indicative of the permissions to: control subsets of the sensors at the devices to turn on or off depending on the permissions; and control the visual indicator or the head-mounted display to indicate the respective status of the subsets of the sensors.

7. The method of claim 6, wherein the states comprise: a cognitive load of a wearer; a valence of the wearer; an arousal of the wearer; or an expression of the wearer.

8. The method of claim 6, wherein the determining the permissions comprises: receiving, at the computing device, from the device, consent data indicating whether the consent for monitoring of the respective state has been granted or not granted.

9. The method of claim 6, further comprising, in response to determining that a respective permission for a device indicates that the consent for monitoring the respective state has not been granted:
communicating, from the computing device, to the device, a request to grant the respective permission;
receiving, at the computing device, from the device, consent data indicative of the consent for monitoring the respective state has been granted; and
communicating, from the computing device, to the device, the respective permission to: control a respective subset of the sensors at the device to turn on; and control a respective visual indicator at the device to indicate the respective status of the respective subset of the sensors at the device.

10. The method of claim 6, wherein a respective permission for the device indicates that the consent for monitoring the respective state has not been granted, the method further comprising, in response to receiving input from an input device:
communicating, from the computing device, to the device, a request to grant the consent for monitoring the respective state;
receiving, at the computing device, from the device, consent data indicative of the consent for monitoring the respective state has been granted; and
communicating, from the computing device, to the device, the respective permission to: control a respective subset of the sensors at the device to turn on; and control a respective visual indicator at the device to indicate the respective status of the respective subset of the sensors at the device.

11. A system comprising:
a permission determination engine to determine a permission indicating whether consent for monitoring a respective state of a wearer of a device has been granted or not granted by the wearer, the device including a head-mounted display, sensors to monitor states of the wearer, subsets of the sensors grouped according to determining respective states of the wearer via monitoring respective body parts of the wearer, and a visual indicator to indicate respective status of the subsets of the sensors;
a sensor control engine to control a respective subset of the sensors for monitoring the respective state of the wearer to be on or off depending on the permission for the respective state;
a permission indication control engine to control the visual indicator or the head-mounted display to indicate whether the consent for monitoring the respective state of the wearer of a device has been granted or not granted by the wearer; and
a state determination engine to determine states of the wearer of the device based on respective sensor data received from the subsets of the sensors.

12. The system of claim 11, wherein the state determination engine is further to receive the respective sensor data with time stamps and determine the states of the wearer based on the respective sensor data by coordinating the respective sensor data based on the time stamps.

13. The system of claim 11, wherein the sensor control engine is further to:
receive, from an input device or a communication interface, input to turn the monitoring of the respective state on or off; and control the respective subset of the sensors to be on or off further depending on the input to turn the monitoring of the respective state on or off.

14. The system of claim 11, wherein the sensor control engine is further to:
receive, from an input device or a communication interface, input to turn the monitoring of the respective state on or off at a plurality of devices, including the device; and control the respective subset of the sensors to be on or off at the plurality of the devices depending on the input to turn the monitoring of the respective state on or off.

15. The system of claim 11, wherein the permission indication control engine is further to control the visual indicator or the head-mounted display to indicate whether consent for monitoring the respective state of the wearer of a device has been granted or not granted by the wearer by: communicating data indicating the consent to the device via a communication interface.
